(19) United States
(12) Patent Application Publication
(10) Pub. No.: US 2017/0060312 A1
(43) Pub. Date: Mar. 2, 2017

(54) TOUCH INPUT DEVICE AND VEHICLE INCLUDING TOUCH INPUT DEVICE

(71) Applicant: HYUNDAI MOTOR COMPANY, Seoul (KR)

(72) Inventors: Sihyun JOO, Seoul (KR); Jeong-Eom LEE, Yongin-si (KR); Jungsang MIN, Seoul (KR); Gi Beom HONG, Bucheon-si (KR)

(21) Appl. No.: 15/078,692

(22) Filed: Mar. 23, 2016

(30) Foreign Application Priority Data
Aug. 25, 2015 (KR) 10-2015-0119452

(51) Int. Cl. G06F 3/041; G06F 3/01

(52) U.S. Cl. CPC G06F 3/0412; G06F 3/017

(57) ABSTRACT

A touch input device includes an outer portion provided with a plurality of areas, wherein a surface of each area is formed to be inclined downward from a mounting surface, and a center portion having a concave shape in the center of the outer portion, wherein the outer portion and the center portion are configured to allow touch input.

### CROSS-REFERENCE TO RELATED APPLICATION(S)

This application claims the benefit of priority to Korean Patent Application No. 10-2015-0119452, filed on Aug. 25, 2015 with the Korean Intellectual Property Office, the disclosure of which is incorporated herein by reference.

### TECHNICAL FIELD

Embodiments of the present disclosure relate to a touch input device having a concave shape and a vehicle including the touch input device.

### BACKGROUND

In general, various electronic devices have been produced through the development of electronic communication technology, and there is a trend that design and convenience of operation is emphasized in such electronic devices. In accordance with such a trend, it may be emphasized that the input device, which is represented by a keyboard or a keypad, is diversified.

A touch input device may be an input device configured to comprise an interface between communication equipment and a user, and may allow the interface between communication equipment and the user to be performed when a user directly touches or moves proximate to a touchpad or a touchscreen by using an input tool such as a finger or a touch pen.

Since the touch input device is easily used by all ages through a simple contact to an input tool, such as a finger or a touch pen, the touch input device may be used in various devices, such as Automated Teller Machines (ATM), Personal

Digital Assistants (PDA), and mobile phone, and in various fields, such as banking, government, tourism and traffic guidance.

In recent years, there has been an effort to apply such a touch input device to health-medical products and vehicles. The touch input device may be implemented in a touchscreen or may be used separately from the display device, and thus utilization of the touch input device may be increased.

### SUMMARY OF THE DISCLOSURE

Therefore, it is an aspect of the present disclosure to provide a touch input device configured to be operable easily by a user while the user watches the front or a screen, and a vehicle including the touch input device.

Additional aspects of the present disclosure will be set forth in part in the description which follows and, in part, will be obvious from the description, or may be learned by practice of the present disclosure.

In accordance with one aspect of the present disclosure, a touch input device includes an outer portion provided with a plurality of areas wherein a surface of each area is inclined downward from a mounting surface, and a center portion having a concave shape in the center of the outer portion. The outer portion and the center portion may be configured to allow touch input.

The plurality of areas may form a certain angle with each other.

The outer portion may include four areas.

The outer portion may include a plurality of flat surfaces.

The center portion may include a concave curved shape.

The outer portion may include a square shape and the center portion may include a spherical surface shape.

The plurality of areas may be provided with a single touch sensor.

The plurality of areas may be provided with touch sensors which are different from each other.

The touch input device may further include a controller for determining a user's gesture based on touch input of the outer portion and the center portion.

The controller may determine a user's swiping gesture based on a touch input of the outer portion.

The controller may determine a direction of the swiping gesture.

The controller may determine a user's swiping gesture based on a touch input of the center portion.

The controller may determine a user's swiping gesture based on a touch input of an edge of the center portion.

The controller may determine a user's tap gesture based on a touch input of the center portion.

The outer portion and the center portion may include a square shape.

The outer portion and the center portion may include a circular shape.

In accordance with another aspect of the present disclosure, a vehicle may include a mounting surface; and a touch input device. The touch input device may include an outer portion provided with a plurality of areas wherein a surface of each area is inclined downward from the mounting surface, and a center portion having a concave shape in the center of the outer portion. The outer portion and the center portion may allow touch input.

The vehicle may further include a display device, wherein the display device may be capable of being connected to the touch input device.

The vehicle may further include a controller for controlling the touch input device and the display device, wherein the controller may select or operate an icon displayed on the display device according to a signal of the touch input device.

The controller may determine a swiping gesture input through the outer portion differently from a swiping gesture input through the center portion.

Each area of the plurality of areas may form a certain angle with each other.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is an exterior view of a vehicle in accordance with an embodiment of the present disclosure;

FIG. 2 is a view of a configuration of a front seat of the inside of the vehicle in accordance with an embodiment of the present disclosure;

FIG. 3 is a view of a configuration of a rear seat of the inside of the vehicle in accordance with an embodiment of the present disclosure;

FIG. 4 is a perspective view of a touch input device in accordance with an embodiment of the present disclosure;

FIG. 5 is a plane view of a touch input device in accordance with an embodiment of the present disclosure;

FIG. 6 is a cross-sectional view taken along line B-B of FIG. 5;

FIGS. 7 to 11 are views illustrating an operation of a touch input device in accordance with an embodiment of the present disclosure, and particularly FIG. 7 is a plane view of inputting flicking, FIG. 8 is a plane view of inputting swiping in an edge of a center portion, FIG. 9 is a plane view of inputting swiping in an outer portion, FIG. 10 is a plane view of inputting a tap, and FIG. 11 is a plane view of inputting swiping from an edge of the center portion to a center part of the center portion;

FIG. 12 is a cross-sectional view of a touch input device in accordance with another embodiment of the present disclosure;

FIG. 13 is a cross-sectional view of a touch input device in accordance with another embodiment of the present disclosure; and

FIG. 14 is a cross-sectional view of a touch input device in accordance with another embodiment of the present disclosure.

### DETAILED DESCRIPTION

In case of adding a reference numeral to components of each drawing, it may be noted that the same component has the same reference numeral although shown in other drawing. If it is determined that a detailed description of commonly-used technologies or structures related to the embodiments of the present disclosure may unnecessarily obscure the subject matter of the present disclosure, the detailed description will be omitted. Further, in the following detailed description, names of components, which are in the same relationship, are divided into “the first”, “the second”, and the like, but the present disclosure is not limited to the order in the following description.

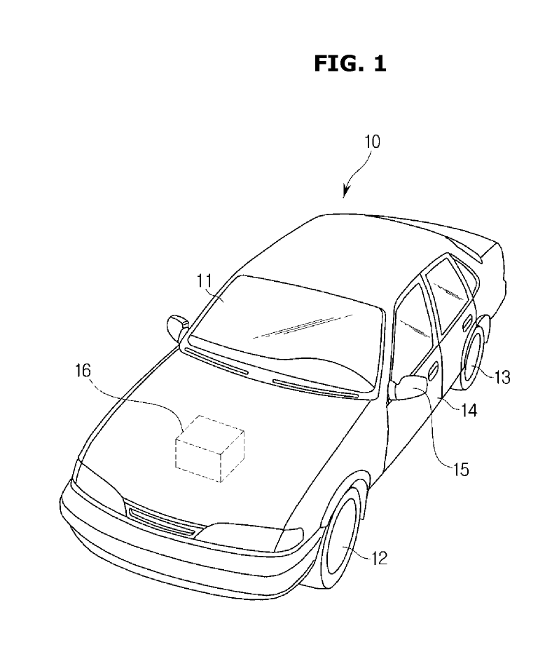

FIG. 1 is an exterior view of a vehicle in accordance with an embodiment of the present disclosure.

Referring to FIG. 1, according to an embodiment, a vehicle may include a body 10 forming an exterior of the vehicle, vehicle wheels 12 and 13 moving the vehicle, a driving device 16 rotating the vehicle wheels 12 and 13, a door 14 closing the inside of the vehicle from the outside, a front glass 11 providing a front view of the vehicle to a driver inside the vehicle, and a side mirror 15 providing a view of a rear side of the vehicle to the driver.

The body 10 may include a hood, a front fender, a roof panel, a door, a trunk lid, and a quarter panel.

The vehicle wheels 12 and 13 may include a front wheel 12 provided on a front of the vehicle and a rear wheel 13 provided on a rear of the vehicle. The driving device 16 may supply a torque to the front wheel 12 and the rear wheel 13 so that the body 10 may be moved forward and backward. The driving device 16 may employ an engine configured to generate a torque by burning a fossil fuel or a motor configured to generate a torque by receiving power source from a capacitor (not shown).

The door 14 may be rotatably provided on a right side and a left side of the body 10. When the door 14 is opened, a driver may be allowed to be seated in the vehicle, and when the door 14 is closed, the inside of the vehicle may be closed from the outside.

The front glass 11 may be provided on an upper portion of the front of the body 10 to allow a driver inside the vehicle to acquire visual information about the front of the vehicle and may be referred to as “windshield glass”.

In addition, a side window may be installed on the door 14 that is on a lateral side of the body 10, and a rear window may be installed on the rear side of the body 10.

The side mirror 15 may include a left side mirror provided on the left side of the body 10 and a right side mirror provided on the right side of the body 10, and may allow a driver inside the vehicle to acquire visual information of the lateral side and the rear side of the vehicle.

In addition, the vehicle may include a detector, e. g. a proximity sensor configured to detect an obstacle and another vehicle in the rear side, and a rain sensor configured to detect whether there is rain and an amount of rain.

The proximity sensor may send a detection signal from the lateral side or the rear side of the vehicle, and may receive a reflection signal reflected from an obstacle or another vehicle. In addition, the proximity sensor may sense whether an obstacle is present in the rear side of the vehicle based on the waveform of the received reflection signal, and may detect a position of the obstacle. Such a proximity sensor may employ a method of emitting ultrasonic waves and detecting a distance to an obstacle by using the reflected ultrasonic waves from the obstacle.

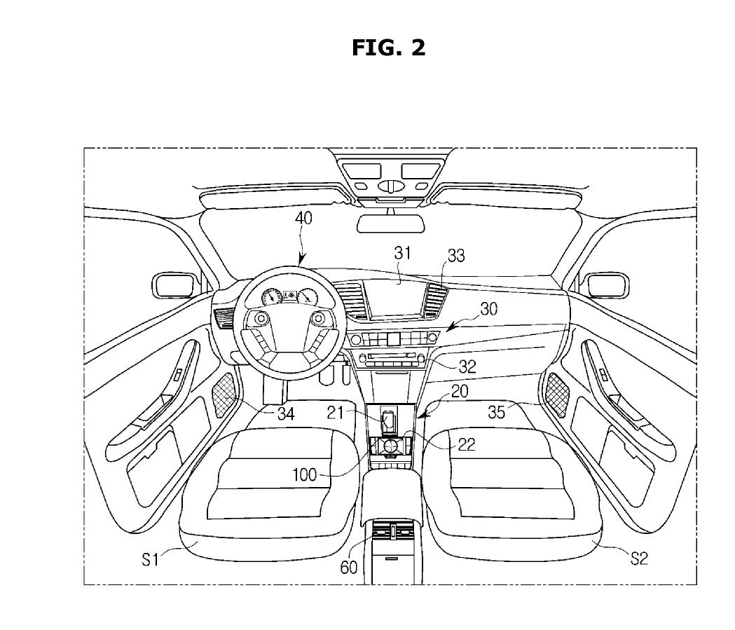

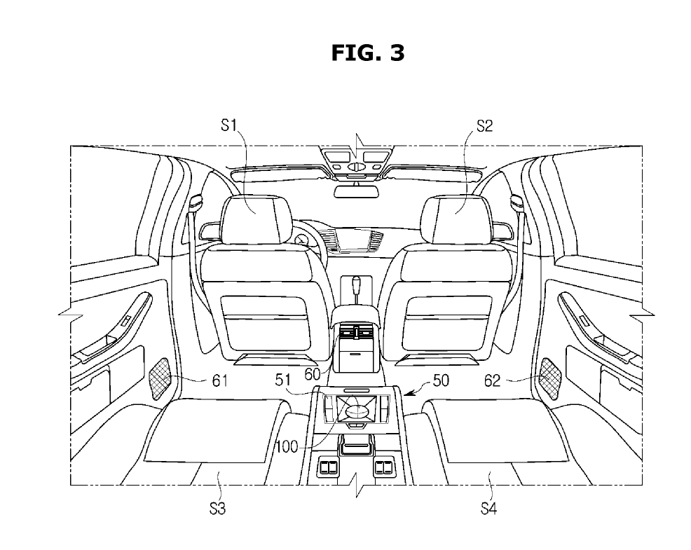

FIG. 2 is a view of a configuration of a front seat of the inside of the vehicle in accordance with an embodiment of the present disclosure and FIG. 3 is a view of a configuration of a rear seat of the inside of the vehicle in accordance with an embodiment of the present disclosure.

Referring to FIG. 2, a seat S1˜S4 in which a driver or a passenger is seated, and a dashboard in which a gear box 20, a center fascia 30, and a steering wheel 40 may be provided in the body 10 of the vehicle.

The seat S1˜S4 may include a driver seat S1 configured to allow a driver to operate the vehicle with comfort and a stable position, and to give a place in which a driver is seated, a passenger seat S2 disposed in the front portion of the body 10 together with the driver seat S1, and a left side seat S3 and a right side seat S4 disposed in the rear side of the body 10.

In the gear box 20, a gear lever 21 configured to change a speed of the vehicle may be installed. In addition, as illustrated the drawings, an input device 22 configured to control a navigation system 31 and an operation of main functions of the vehicle may be installed in the gear box 20.

In a center fascia 30, an air conditioning device 33, a clock, an audio device 32 and a navigation system 31 may be installed. The air conditioning device 33 may keep an air inside the vehicle fresh by controlling temperature, humidity, air cleanliness, and a flow of air inside of the vehicle. The air conditioning device 33 may include at least one discharging port installed in the center fascia 30 and configured to discharge air. A button or a dial may be installed in the center fascia 30 to control the air conditioning device 33. A user, such as a driver, may control the air conditioning device 33 by using a button or a dial disposed on the center fascia 30.

According to an embodiment, in the center fascia 30, the navigation system 31 may be installed. The navigation system 31 may be formed to be embedded in the center fascia 30 of the vehicle. According to an embodiment, an input unit configured to control the navigation system 31 may be installed in the center fascia 30. Alternatively, the input unit of the navigation system 31 may be installed in another position other than the center fascia 30. For example, the input unit of the navigation system 31 may be formed around a display unit of the navigation system 31. Alternatively the input unit of the navigation system 31 may be installed in the gear box 20.

The audio device 32 may include an operation panel in which a number of buttons are provided to perform functions of the audio device 32. The audio device 32 may provide a radio mode configured to provide a radio function, and a media mode configured to play an audio file of various storage media in which the audio file is stored. The buttons formed in the operation panel of the audio device 32 may be classified into a button configured to provide a function related to the radio mode, a button configured to provide a function related to the media mode, and a button configured to be used commonly in both modes.

The audio device 32 may deliver sound through a speaker 34, 35, 61, and 62 provided inside the body 10. The speaker may include a speaker 34 provided in the left side door of the driver seat S1, a speaker 35 provided in the right door of the passenger seat S2, and speakers 61 and 62 provided in the rear seats.

The steering wheel 40 may be a device configured to adjust a driving direction of the vehicle, and may include a rim held by the driver and a spoke connected to a steering system of the vehicle and configured to connect the rim to a hub of a rotation shaft for the steering. According to the embodiment, manipulation devices may be formed in the spoke to control various devices inside the vehicle, such as an audio device.

According to the embodiment, the dashboard may further include various gauge boards indicating a driving speed of the vehicle and revolutions per minute (RPM) or fuel residual quantity, and a globe box in which various things may be stored.

Referring to FIG. 3, between the left seat S3 and the right seat S4 both of which are placed in the rear of the body 10, an armrest 50 configured to allow a back seat passenger to rest his/her arm may be provided. In the armrest 50, an input device 51 for the back seat passenger may be provided. The input device 51 may include a variety of buttons or dials. Although not shown in the drawings, the input device 51 may include a touch panel.

The back seat passenger may operate the audio device 32 (refer to FIG. 2) in the body 10 by using the input device 51. Particularly, a passenger seated in the left seat S3 of the back seat may adjust a volume of the speaker 61 provided in the left door of the back seat, and a passenger seated in the right seat S4 of the back seat may adjust a volume of the speaker 62 provided in the right door of the back seat.

The back seat passenger may adjust an air volume of the air conditioning device 33 through the input device 51. In addition, the back seat passenger may operate a variety of convenience devices of the body 10 through the input device 51.

The input device 22 disposed in the front seat and the input device 51 disposed in the back seat may be connected to display devices in the vehicle, and thus a variety of icons displayed in the display devices may be selected or operated.

The display devices installed in the vehicle may include the audio device 32, the navigation system 31, or the gauge panel. As needed, the display device may be installed in the gear box 20. In addition, the display device may be connected to a Head Up Display (HUD) or a back mirror.

For example, the input device 22 disposed in the front seat and the input device 51 disposed in the back seat may move a cursor or operate an icon, both of which may be displayed on the display device. The icon may include a main menu, a selection menu, and a setting menu. In addition, through the input device 22 disposed in the front seat and the input device 51 disposed in the back seat, the navigation may be operated, a driving condition of the vehicle may be set or adjacent devices of the vehicle may be operated.

The input device 22 disposed in the front seat and the input device 51 disposed in the back seat may be implemented by a touch input device 100 configured to allow touch input.

According to an embodiment, the touch input device 100 may be installed in the gear box 20.

According to an embodiment, the touch input device 100 may be installed in the armrest 50 of the back seat in the vehicle. The armrest 50 may be generally installed between the left seat S3 and the right seat S4 of the back seat in the vehicle, and a cup holder or the input device 51 including a variety of buttons may be provided in the armrest 50 so that the convenience of the back seat passenger may be improved.

The touch input device 100 according to an embodiment may be installed in a position, which is different from the input device 22 and 51 illustrated in FIGS. 2 and 3, and thus the type of the installation may be not limited thereto.

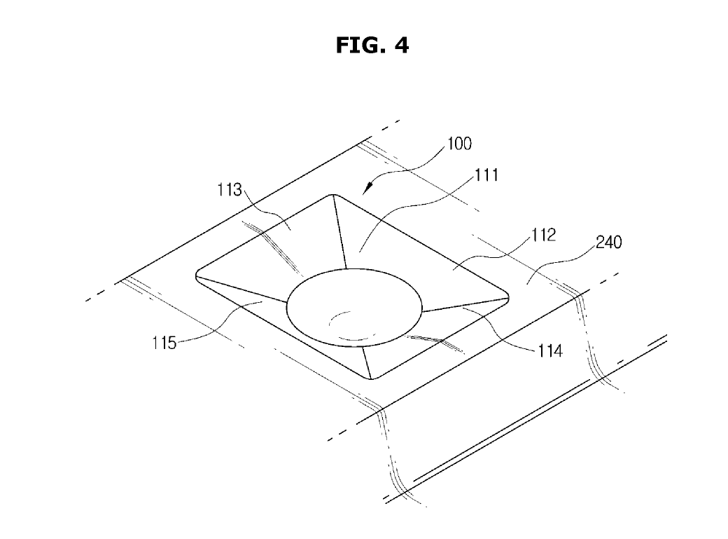

Hereinafter the touch input device 100 according to an embodiment will be described with reference to FIG. 4.

FIG. 4 is a perspective view of a touch input device in accordance with an embodiment of the present disclosure.

According to an embodiment, the touch input device 100 may include a gesture input tool configured to allow a user to input a gesture by touch. The gesture input tool may include a center portion 111 formed to be concave, and an outer portion 112 to 115 disposed to an outer portion of the center portion 111. The outer portion 112 to 115 may be formed by a member separated from the center portion 111.

The center portion 111 and the outer portion 112 to 115 may include a touch pad in which a signal is input when a user touches or closes thereto, or moves proximate to, by using a pointer, such as a finger or a touch pen. The user may input a desired instruction or command by inputting a pre-determined touch gesture to the center portion 111 and the outer portion 112 to 115.

Regardless of the name of touch pad, the touch pad may include a touch film, or a touch sheet including a touch sensor. The touch pad may include a touch panel, which is a display device provided with a touchable screen.

Meanwhile, recognizing a position of the pointer in a state in which the pointer is adjacent to the touch pad without touching the touch pad may be referred to as “proximity touch”, and recognizing a position of the pointer in a state in which the pointer is contacted to the touch pad may be referred to as “contract touch”. A position where proximity touch occurs may be a position vertically corresponding to the pointer with respect to the touch pad when the pointer is close to the touch pad.

The touch pad may use resistive technology, optical technology, capacitive technology, ultrasound technology and pressure technology, but is not limited thereto. A well-known technology may be used for the touch pad.

The touch input device 100 according to an embodiment may be installed in a mounting surface 240 configured to support a user's wrist.

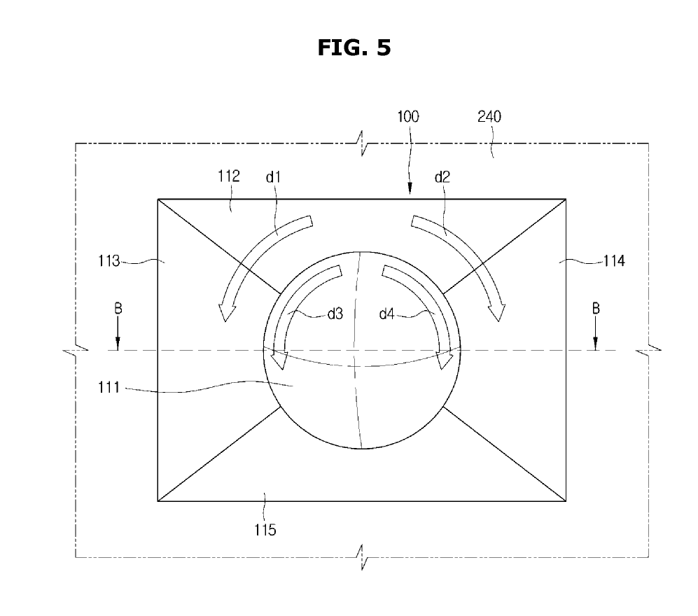

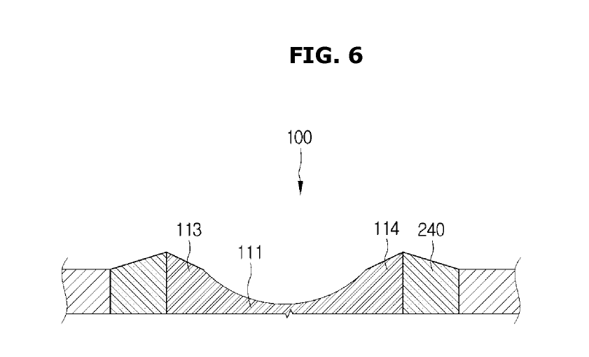

FIG. 5 is a plane view of a touch input device in accordance with an embodiment of the present disclosure and FIG. 6 is a cross-sectional view taken along line B-B of FIG. 5.

The center portion 111 may have a concave shape in the center of the outer portion 112 to 115 surrounding the center portion 111. The concave shape may represent a dent or a recessed shape, and may include a dent shape to be inclined or to have a step well as a dent shape to be circle. For example, the center portion 111 may include a concave curved shape.

The center portion 111 according to an embodiment may be a concave curved shape having a certain curvature. The curvature of the center portion 111 may vary. For example, the curvature of the center part of the center portion 111 may be large, that is the radius of curvature of the center may be small, and the curvature of the center portion 111 may be smaller as closing to the edge of the center portion 111, that is the radius of curvature of the edge may be large.

The center portion 111 may include a curved surface, and thus when inputting a gesture, a sense of touch or a sense of operation, which is felt by the user, may be improved. The curved surface of the center portion 111 may be provided to be similar with a trajectory which is made by a movement of the end of the finger when a person moves the finger or rotates or twists a wrist with stretching the finger, in a state in which a person fixes her/his wrist.

In comparison with conventional flat surface, the center portion 111 having a concave curved surface may be formed in an ergonomic manner.

That is, stress applied to the wrist may be reduced in addition to a sense of operation of a user being improved. In addition, in comparison with a case of inputting a gesture to a flat surface, the input accuracy may be enhanced.

The center portion 111 may be formed in a circular or ovular shape. When the touch center portion 111 is provided in a circular or oval, or ovular, shape, a concave curved surface may be easily formed. In addition, since the center portion 111 is formed in a circular or ovular shape, a user may detect a touch area of the center portion 111 by tactility and thus a user may easily input a rolling or a spin gesture.

Since the center portion 111 has a curved surface, a user may intuitively recognize that a finger is placed in a position of the center portion 111. The center portion 111 may have a curved surface so that an inclination may vary according to a portion of the center portion 111. Therefore, the user may intuitively recognize that a finger is placed in a certain position of the center portion 111 through a sense of inclination, which is felt through the finger.

Accordingly, when the user inputs a gesture to the center portion 111 in a state in which the user looks at a point besides the center portion 111, a feedback related to a position of the center portion 111 where the finger is placed, may be provided to help the user to input a needed gesture, and may improve the input accuracy of gesture.

A touch pad used in the center portion 111 provided in a curved surface may recognize a touch by using optical technology. For example, on a rear surface of the curved center portion 111, Infrared Light Emitting Diode (IR LED) and a photodiode array may be disposed. The IR LED and photodiode array may acquire an infrared image reflected by a finger, and a controller may extract a touch point from the acquired image.

A diameter and a depth of the center portion 111 may be formed in an ergonomic manner.

The center portion 111 may receive an input of a swiping gesture. For example, a user may input a swiping gesture along the edge of the center portion 111. The user may input a swiping gesture along the edge of the center portion 111 clockwise (d4), or counterclockwise (d3). The swipe may represent inputting a gesture in a state in which a point is not separated from the touch pad.

A swiping gesture may be recognized as a different gesture by changing a start point and an end point of the swiping gesture.

In addition, in a state in which a user inputs a swiping gesture by contacting to the same point by using the finger, when an end point of the gesture, that is a position where the finger is off, is different, the gestures may be recognized differently from each other.

For example, a cursor displayed on the display device may be moved according to a path in which the finger is passed during swiping gesture. In a state in which various characters are arranged in a row on the display device, a selected character may be moved by a space to the next each time the user passes the edge of the center portion 111 in clockwise (d4) and counterclockwise (d3) while performing the swiping gesture.

A tap gesture may be input on the center portion 111. That is, a user may input various commands and instructions according to a position of the center portion 111 on which the user taps.

In addition, a gesture, which is drawn, may be input on the center portion 111. A user may input a predetermined operation signal on the center portion 111 by drawing a number, a character, and a predetermined gesture. For example, the user may input a letter of “A” on the center portion 111 so as to input “A” on an input box of the display device. The user may directly input a character on the center portion 111, thereby inputting a character, which is to be input, more easily and quickly in comparison with selecting a corresponding character in a character table which is arranged on the display device.

The outer portion 112 to 115 may include a lower portion than the mounting surface 240. That is, a touch area of the outer portion 112 to 115 may be provided to be lower than a boundary between the outer portion 112 to 115 and the mounting surface 240. For example, the touch area of the outer portion 112 to 115 may be provided to be inclined downward from the boundary of the mounting surface 240 or to have a step from the boundary of the mounting surface 240. In this case, the touch input device 100 according to an embodiment may include a concave shape, which is recessed downward from the mounting surface 240.

Since the outer portion 112 to 115 may include a lower portion than the boundary of the mounting surface 240, a user may recognize the area of the outer portion 112 to 115, and the boundary between the outer portion 112 to 115 and the mounting surface 240 by tactility.

According to an embodiment, the outer portion 112 to 115 may be divided into a plurality of areas with respect to the center of the center portion 111. Hereinafter an outer portion disposed in an upper portion of the center portion 111 may be referred to as an upper outer portion 112, an outer portion disposed in a left portion of the center portion 111 may be referred to as a left outer portion 113, an outer portion disposed in a right portion of the center portion 111 may be referred to as a right outer portion 114, and an outer portion disposed in a lower portion of the center portion 111 may be referred to as a lower outer portion 115.

Each area of the outer portion 112 to 115 may be formed by the same material or by a separate material.

As illustrated in FIG. 5, a boundary between each area 112 to 115, which are formed in a convex or concave shape so that a user recognizes those, may be disposed on the outer portion, or as illustrated in FIG. 4, each area 112 to 115 of the outer portion formed in a flat surface or a curved surface, may form a certain angle with, or between, each other. Therefore, the user may naturally recognize the boundary between each area 112 to 115 of the outer portion.

The outer portion may be provided as the plurality of areas 112 to 115, and the boundary between each area may be provided so that the user may recognize the boundary between each area 112 to 115 by tactility and a touch signal corresponding to each area 112 to 115 may be input.

In addition, as illustrated in FIG. 4, the outer portion 112 to 115 may be provided to be inclined downward (toward the center portion 111) along an outer edge of the outer portion 112 to 115. The center portion 111 may be formed to have a part of a spherical surface, and the outer portion 112 to 115 may be provided to surround a circumference of the center portion 111.

A swiping gesture may be input on the outer portion 112 to 115. For example, the user may input the swiping gesture while drawing an outer edge of the center portion 111 on the outer portion 112 to 115. The user may input the swiping gesture in clockwise (d2) and/or counterclockwise (d1) directions along the outer portion 112 to 115.

The swiping gesture may be recognized as a different gesture by changing a start point and an end point of the swiping gesture.

For example, a swiping gesture that is input in the left outer portion 113, and a swiping gesture that is input in the right outer portion 114 may lead to different operations, which are different from each other.

In addition, in a state in which a user inputs a swiping gesture by contacting to the same point by using the finger, when an end point of the gesture, that is a position where the finger is no longer in contact with the outer portion 112 to 115, is different, the gestures may be recognized differently from each other. For example, when inputting a swiping gesture from the left outer portion 113 to the upper outer portion 112, and when inputting a swiping gesture from the left outer portion 113 to the right outer portion 114 by passing the upper outer portion 112, those gestures may be recognized as different gestures.

According to an embodiment, a cursor displayed on the display device may be moved according to a path in which a finger is passed during a swiping gesture. In a state in which various characters are arranged in a row on the display device, a selected character may be moved by one space to the next each time the user passes the edge of the center portion 111 in clockwise (d2) and/or counterclockwise (d1) directions while performing the swiping gesture.

Meanwhile, as mentioned above, when the outer portion 112 to 115 and the center portion 111 are configured to allow an input of a swiping gesture, a swiping gesture of the outer portion 112 to 115 and a swiping gesture of the center portion 111 may be differently recognized.

For example, in a state in which a variety of service operation icons, e. g navigation operation icon, phone operation icon, radio operation icon, and media operation icon are arranged in a row, when a swiping gesture is input in the outer portion 112 to 115, a certain service operation icon may be selected according to the direction and the movement distance of the swiping gesture.

In a state in which a variety of characters as well as a variety of service operation icons are arranged in a row on the display device, when a swiping gesture is input in the center portion 111, a cursor configured to select a character may be moved according to the direction and the movement distance of the swiping gesture.

In addition, in various embodiments, e.g. a page, which is currently watched by a user, may be changed according to the input of the swiping gesture in the outer portion 112 to 115, or music, which is currently played, may be moved to the next audio file according to the input of the center portion 111, but is not limited thereto.

The swiping gesture of the center portion 111 and the outer portion 112 to 115 may be divided, and thus when a low resolution is needed, a user may input a swiping gesture in the outer portion 112 to 115 having a relatively large area, and when a high resolution is needed, a user may input a swiping gesture in the center portion 111 having a relatively small area.

A tap gesture may be input on the outer portion 112 to 115. That is, a user may input various commands and instructions according to a position of the outer portion 112 to 115 on which the user taps.

For example, the user may operate a program related to the navigation by inputting the tap gesture in the upper outer portion 112, a program related to the phone by inputting the tap gesture in the left outer portion 113, a program related to the radio by inputting the tap gesture in the right outer portion 114, and a program related to the media by inputting the tap gesture in the lower outer portion 115.

According to an embodiment, a tangential inclination of the outer portion 112 to 115 in the boundary between the center portion 111 and the outer portion 112 to 115 may be provided to be smaller than an inclination of the center portion 111. The user may intuitively distinguish between the center portion 111 and the touch area of the outer portion 112 to 115 since the inclination of the center portion 111 is larger than that of the outer portion 112 to 115.

Meanwhile, while a gesture is input to the center portion 111, a touch of the outer portion 112 to 115 may be not recognized. Therefore, although the user reaches the boundary of the outer portion 112 to 115 during inputting the gesture to the center portion 111, a gesture input to the outer portion 112 to 115 and a swiping gesture input to the center portion 111 may be not overlapped.

According to an embodiment, the center portion 111 and the outer portion 112 to 115 may be integrally formed.

Meanwhile, a touch sensor may be provided in the center portion 111 and the outer portion 112 to 115, respectively, or a single touch sensor may be provided in the center portion 111 and the outer portion 112 to 115. When the center portion 111 and the outer portion 112 to 115 are provided with a single touch sensor, the controller may distinguish the touch area of the center portion 111 from the touch area of the outer portion 112 to 115 and thus may distinguish a gesture input signal of the center portion 111, from a gesture input signal of the outer portion 112 to 115.

The touch sensor may be provided in the upper outer portion 112, the left outer portion 113, the right outer portion 114, and the lower outer portion 115, respectively.

According to an embodiment, the touch input device 100 may be included in the above-mentioned vehicle related to FIGS. 1 to 3. The controller may receive a user's touch or a user's gesture, which is recognized by the touch input device 100, may analyze the touch or the gesture, and then may deliver an operation command to a variety of devices of the vehicle according to the result of the analysis. For example, when a user inputs a gesture in the touch input device 100 to operate the navigation system 31 (refer to FIG. 2), the controller may analyze the gesture and then deliver the operation command to the navigation device 31.

The controller may recognize a gesture input to the center portion 111 and the outer portion 112 to 115, and give a command to various devices by analyzing, or as a result of, the gesture.

The controller may move a cursor or a menu on the display device according to a position of a pointer moved on the center portion 111 and the outer portion 112 to 115. That is, when the pointer moves from the upper side to the lower side, a cursor displayed on the display device may be moved in the same direction or a pre-selected menu may be moved to a sub menu from a top menu.

The controller may analyze a trajectory, in which the pointer is moved, may correspond to a pre-determined gesture, and then may operate a command which is defined as, or corresponds to, the corresponding gesture. The gesture may be input in a way that the pointer performs flicking, rolling, spin, or tap. In addition, the user may input a gesture by using a variety of touch input methods.

Flicking may represent a touch input method performed in a way that a pointer is moved in one direction while being contacted to the center portion 111 or the outer portion 112 to 115, and then the contact state is released, rolling may represent a touch input method of drawing an arc in the center portion 111 or the outer portion 112 to 115 with respect to the center of the center portion 111, spin may represent a touch input method of drawing a circle in the center portion 111 or the outer portion 112 to 115 with respect to the center of the center portion 111, and tap may represent a touch input method of tapping the center portion 111 or the outer portion 112 to 115.

The controller may include a memory configured to store a program and data to control the touch input device 100 and the display device, and a processor configured to generate a control signal according to the stored program and data.

A user may input a gesture by using a multi-pointer input technology. The multi-pointer input technology may represent a method of inputting a gesture in a state in which two pointers are contacted simultaneously or sequentially. For example, a gesture may be input while two fingers are contacted to the center portion 111. By using the multi-pointer input technology, a single pointer input technology and inputting a gesture may be allowed, and thus a variety of commands or instructions, which are input by a user, may be provided.

The user may input a gesture by drawing a character, number, or symbol. For example, Korean consonants and vowels, Alphabetic symbols, Arabic numerals, and four arithmetic symbols may be drawn. The user may directly input a character or number intended to be input, so that an input time may be reduced and an intuitive interface may be provided.

The center portion 111 or the outer portion 112 to 115 may be provided to allow pressing a gesture or a tilting gesture. Accordingly, a user may press or tilt a part of the center portion 111 or the outer portion 112 to 115 by pressing the center portion 111 or the outer portion 112 to 115 so that a user may input an operation signal corresponding to the pressing or the tilting. The pressing gesture may include a case in which the center portion 111 or the outer portion 112 to 115 is pressed in a flat manner and a case in which the center portion 111 or the outer portion 112 to 115 is pressed in a tilted manner. In addition, when the center portion 111 or the outer portion 112 to 115 is provided to be flexible, only a single part of the center portion 111 or the outer portion 112 to 115 may be pressed.

A user may input a certain instruction or command by pressing or tilting the center portion 111 or the outer portion 112 to 115 with pressure. For example, when pressing the central portion of the center portion 111, the user may operate a selected icon or a selected menu, and when pressing the upper outer portion 112, the user may move a cursor toward the upper portion.

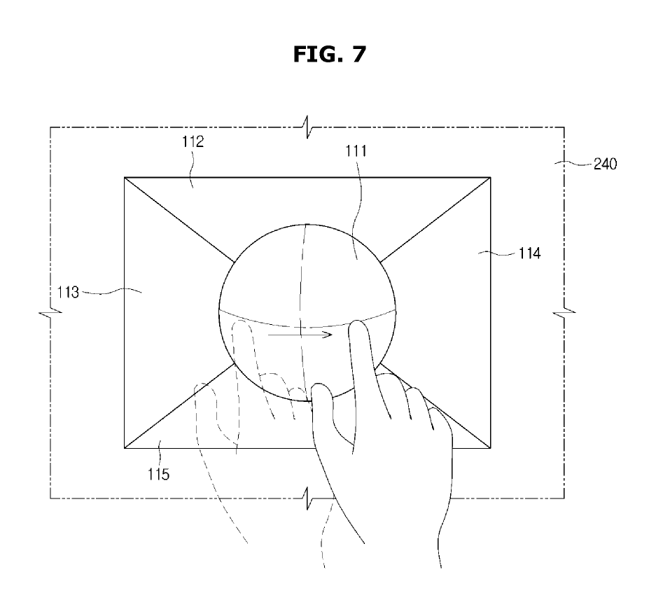

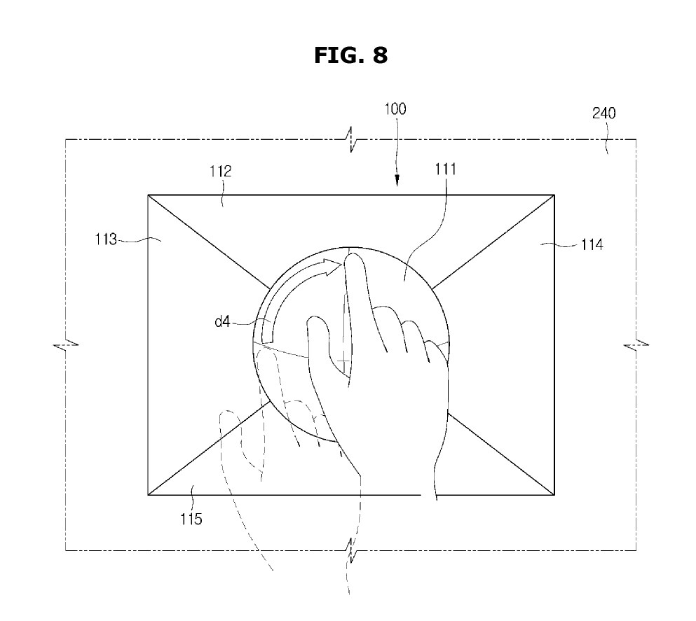

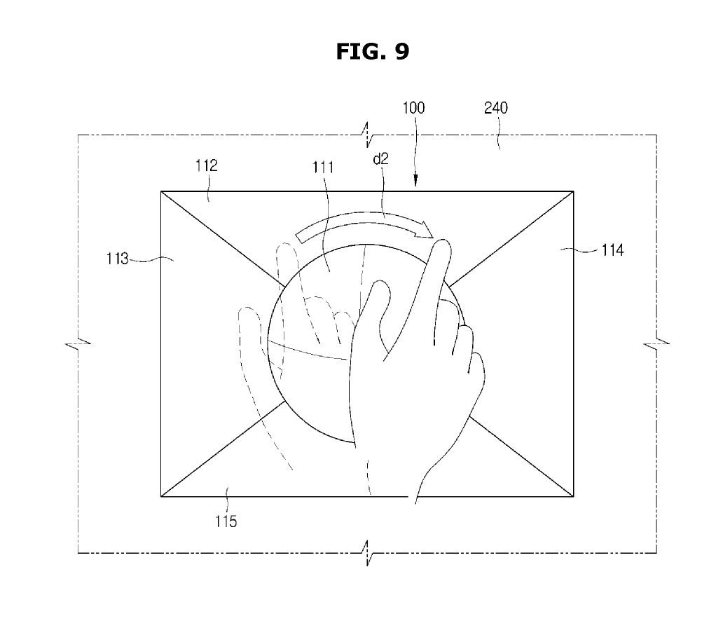

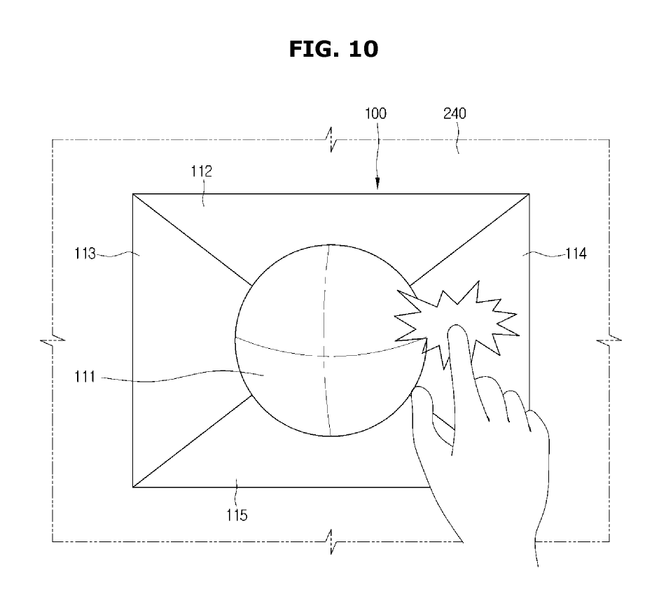

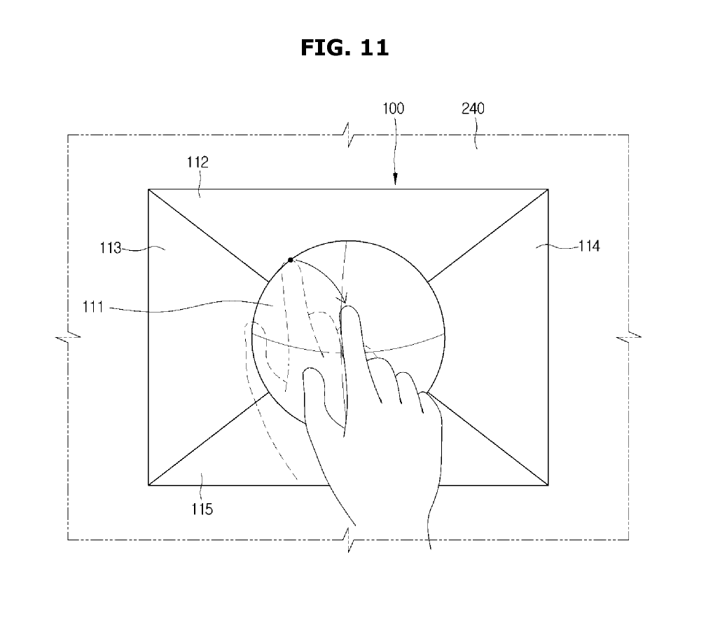

FIGS. 7 to 11 are views illustrating an operation of a touch input device in accordance with an embodiment of the present disclosure, particularly FIG. 7 is a plane view of inputting flicking, FIG. 8 is a plane view of inputting swiping in an edge of a center portion, FIG. 9 is a plane view of inputting swiping in an outer portion, FIG. 10 is a plane view of inputting a tap, and FIG. 11 is a plane view of inputting swiping from an edge of the center portion to a center part of the center portion.

Referring to FIG. 7, a user may input a gesture command by drawing a gesture in the center portion 111. FIG. 7 illustrates a flicking gesture in which a pointer is moved from the left side to the right side. The pointer may be moved from the right side to the left side.

Referring to FIG. 8, the user may input a gesture command by rubbing that corresponds to rolling or spin, on an edge of the center portion 111. FIG. 8 illustrates a swiping gesture in which the pointer is moved in the edge of the center portion 111 in a clockwise (d4) direction. The pointer may be moved in a counterclockwise direction, and the start point and the end point of the pointer may be not limited to those shown in FIG. 8.

Referring to FIG. 9, the user may input a gesture command by rubbing that corresponds to rolling or spin, on the outer portion 112 to 115. FIG. 9 illustrates a swiping gesture in which the pointer is moved in the upper outer portion in a clockwise (d2) direction. The pointer may be moved in a counterclockwise direction, and the start point and the end point of the pointer may be not limited to those shown in FIG. 9. The swiping gesture may be input in a certain area of the outer portion, as illustrated in FIG. 9, or may be input in a plurality of areas of the outer portion. For example, the start point of the tap gesture may be the upper outer portion 112 and the end point of the tap gesture may be the right outer portion 114.

Referring to FIG. 10, the user may input a tap gesture by tapping the outer portion 112 to 115. FIG. 10 illustrates inputting the tap gesture in the right outer portion 114. The tap gesture may be input in the right outer portion 114, as illustrated in FIG. 10, and alternatively may be input in another portion 112, 113 and 115.

Referring to FIG. 11, the user may input a swiping gesture by rubbing from the edge of the center portion 111 to the center of the center portion 111. In contrast to what is shown in FIG. 11, the user may input the swiping gesture from the center of the center portion 111 to the edge of the center portion 111. When a variety of characters are arranged in a row on the display device, the swiping gesture from the edge of the center portion 111 to the center of the center portion 111 may correspond to a gesture for selecting a certain character, and the swiping gesture from the center of the center portion 111 to the edge of the center portion 111 may correspond to a gesture for canceling a selection a certain character.

Although not shown in the drawings, a variety of components related to operations may be built in the touch input device 100. A structure configured to allow the center portion 111 or the outer portion 112 to 115 to be pressed or tilted in a certain direction may be included in the touch input device 100.

In addition, a variety of semiconductor chips and Printed Circuit Boards (PCB) may be installed in the touch input device 100. The semiconductor chip may be installed in the PCB. The semiconductor chip may perform information processes or store data. The semiconductor chip may analyze a certain electrical signal, which may be generated by an external force applied to the touch input device 100, and a gesture recognized in the center portion 111 may generate a certain control signal according to the analyzed content, and may transmit the control signal to a controller of another device or the display device.

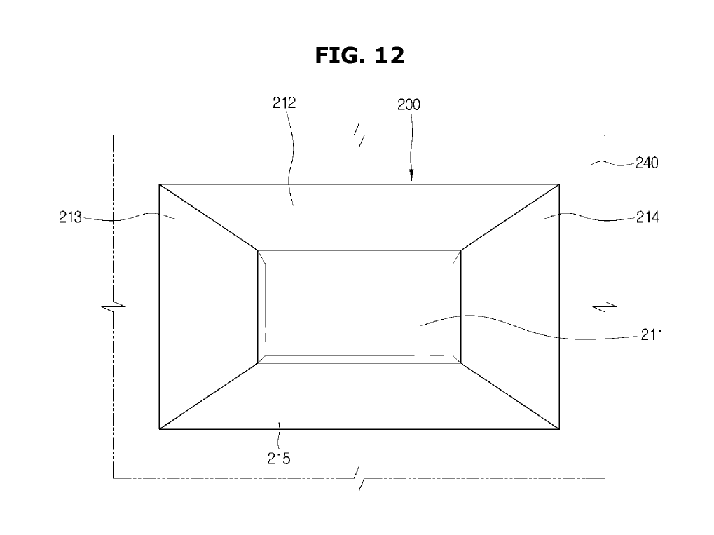

FIG. 12 is a cross-sectional view of a touch input device in accordance with another embodiment of the present disclosure;

Referring to FIG. 12, a touch input device 200 in accordance with another embodiment may include a center portion 211 having a polygonal, for example a square, shape. The center portion 211 may be formed in a polygonal shape so that a boundary between an outer portion 212 to 215 and the center portion 211 may be more clearly recognized by a user. In this case, the center portion 211 may be provided by a flat surface or a curved surface having an inclination. The boundary between the outer portion 212 to 215 and the center portion 211 may comprise a smooth curved line.

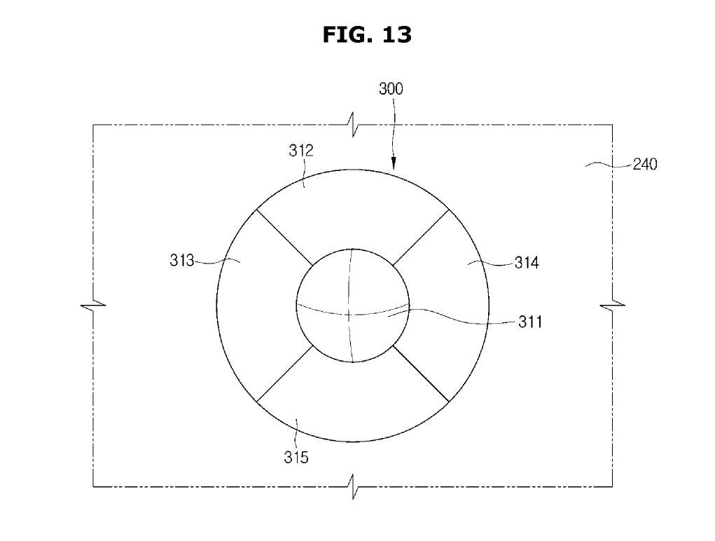

FIG. 13 is a cross-sectional view of a touch input device in accordance with another embodiment of the present disclosure.

Referring to FIG. 13, a touch input device 300 in accordance with another embodiment may have an outer portion 312 to 315 having a circular or an ovular shape. The outer portion 312 to 315 may be formed in the circular or oval, or ovular, shape so that a user may feel an aesthetic sense in a design thereof.

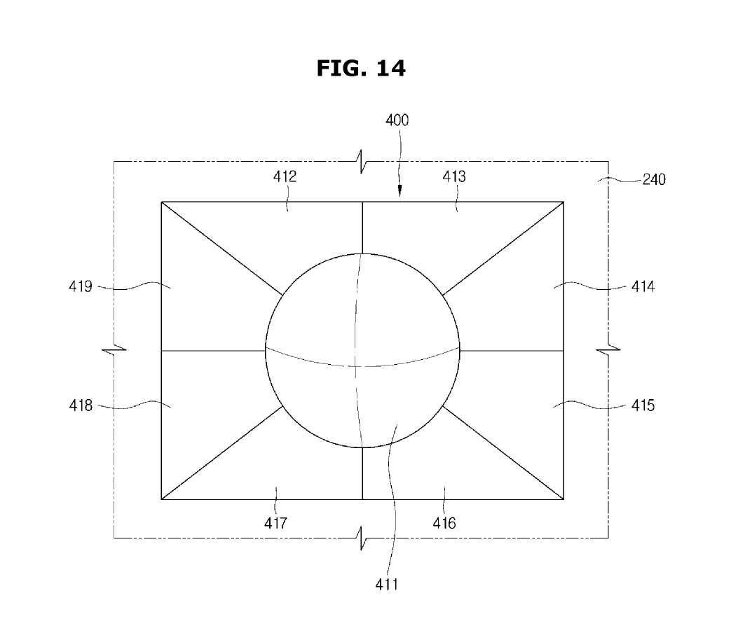

FIG. 14 is a cross-sectional view of a touch input device in accordance with another embodiment of the present disclosure.

Referring to FIG. 14, an outer portion of a touch input device 400 in accordance with another embodiment may be divided into four or more areas. In this case, a plurality of areas 412 to 419 of the outer portion may be formed by a flat surface or a curved surface, all of which form a certain angle with each other. FIG. 14 illustrates a case in which the outer portion 412 to 419 is divided into eight areas, but the number of areas is not limited thereto. The outer portion 412 to 419 may be provided with the plurality of areas so that a user may specifically recognize the position of the pointer and may specifically operate the touch input device 400.

As is apparent from the above description, according to the proposed touch input device, a user may control an external device connected to the touch input device in various manners, particularly intuitively and easily move a cursor and/or select a character. In this case, the user may operate the touch input device by tactility without watching the touch input device for the operation thereof.

By using a vehicle provided with the above-mentioned touch input device, in a state in which a user fixes his/her wrist, the user may operate the touch input device while putting his/her finger into the concave touch input device so that feeling of fatigue in the wrist may be reduced.

It is described that the touch input device 100 in accordance with an embodiment is installed in the above mentioned vehicle, but the touch input device is not limited thereto. The touch input device 200, 300, and 400 in accordance with various embodiments may, or may not, be installed thereto.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is;

1. A touch input device comprising:
an outer portion provided with a plurality of areas, wherein a surface of each area is inclined downward from a mounting surface; and
a center portion having a concave shape in the center of the outer portion,
wherein the outer portion and the center portion are configured to allow touch input.

2. The touch input of claim 1, wherein each area of the plurality of areas forms a certain angle with each other.

3. The touch input of claim 2, wherein the outer portion comprises four areas.

4. The touch input of claim 1, wherein the outer portion comprises a plurality of flat surfaces.

5. The touch input of claim 1, wherein the center portion comprises a concave curved shape.

6. The touch input of claim 1, wherein the outer portion comprises a square shape and the center portion comprises a spherical surface shape.

7. The touch input of claim 1, wherein the plurality of areas is provided with a single touch sensor.

8. The touch input of claim 1, wherein each area in the plurality of areas is provided with a touch sensor which is different from that of each other area.

9. The touch input of claim 1, further comprising a controller for determining a user's gesture based on touch input of the outer portion and the center portion.

10. The touch input of claim 9, wherein the controller determines a user's swiping gesture based on touch input of the outer portion.

11. The touch input of claim 10, wherein the controller determines a direction of the swiping gesture.

12. The touch input of claim 9, wherein the controller determines a user's swiping gesture based on a touch input of the center portion.

13. The touch input of claim 12, wherein the controller determines a user's swiping gesture based on a touch input of an edge of the center portion.

14. The touch input of claim 12, wherein the controller determines a user's tap gesture based on another touch input of the center portion.

15. The touch input of claim 1, wherein the outer portion and the center portion comprise a square shape.

16. The touch input of claim 1, wherein the outer portion and the center portion comprise a circular shape.

17. A vehicle, comprising:
a mounting surface; and
a touch input device comprising an outer portion provided with a plurality of areas wherein a surface of each area is inclined downward from the mounting surface, and a center portion having a concave shape in the center of the outer portion, wherein the outer portion and the center portion allow touch input.

18. The vehicle of claim 17, further comprising a display device, wherein the display device is capable of being connected to the touch input device.

19. The vehicle of claim 18, further comprising a controller for controlling the touch input device and the display device, wherein the controller selects or operates an icon displayed on the display device according to a signal of the touch input device.

20. The vehicle of claim 18, wherein the controller determines a swiping gesture input through the outer portion differently from a swiping gesture input through the center portion.

21. The vehicle of claim 17 wherein each area of the plurality of areas form a certain angle with each other.
